(19) United States
(12) Patent Application Publication
(10) Pub. No.: US 2017/0124071 A1
(43) Pub. Date: May 4, 2017

(54) METHOD AND SYSTEM FOR STATISTICS-BASED MACHINE TRANSLATION

(71) Applicant: Alibaba Group Holding Limited, George Town (KY)

(72) Inventors: Rui Huang, Hangzhou (CN); Weihua Luo, Hangzhou (CN); Feng Lin, Hangzhou (CN); Xing Xu, Hangzhou (CN)

(73) Assignee: Alibaba Group Holding Limited, George Town (KY)

(21) Appl. No.: 15/296,907

(22) Filed: Oct. 18, 2016

(30) Foreign Application Priority Data
Oct. 30, 2015 (CN) 201510726342.6

(51) Int. Cl. G06F 17/28

(52) U.S. Cl. CPC G06F 17/2818; G06F 17/289; G06F 17/2854

(57) ABSTRACT

Embodiments of the present application provide a method and system for statistics-based machine translation. During operation, the system may obtain at least one text to be translated and localized information. The system may decode the text to be translated. The system may then generate a plurality of candidate translations for the text to be translated. For each candidate translation of the plurality of candidate translations, the system may obtain linguistic translation features according to the text to be translated and the candidate translation. The system may extract localized translation features according to the localized information. The system may then apply a translation quality prediction model to calculate translation quality scores for the plurality of candidate translations according to the linguistic translation features and the localized translation features. The system may select a predetermined number of candidate translations with highest translation quality scores as translations of the text to be translated.

### RELATED APPLICATION

Under 35 U.S.C. 119, this application claims the benefits and rights of priority of Chinese Patent Application No. 201510726342.6, filed 30 Oct. 2015.

### BACKGROUND

Field

The present invention relates to machine translation, and particularly relates to a method and system for statistics-based machine translation. The present invention also relates to a method and system for generating a translation quality prediction model.

Related Art

International e-commerce is an emerging market that has developed rapidly in recent years, but one of the factors limiting its development is the language barrier. Currently, most multilingual websites provide translations from a native language to other languages in order to rapidly seize international market share. A good machine translation engine can, to a large extent, reduce the cost of doing business in a multilingual market, and help multilingual users overcome the language barrier.

Machine translation refers to translating text expressed in one language to text expressed in another language. In this process, translation features and feature weight affects the translation result. Translation features, on which the traditional machine translation method is based, include linguistic translation features of candidate translations. For example, these linguistic translation features may include forward phrase translation probability, reverse phrase translation probability, forward lexical translation probability, reverse lexical translation probability, phrase penalty, word penalty, reordering model probability, and language model probability. After computing and obtaining the linguistic translation features, a machine translation system may use a translation quality prediction model (mainly including a weight value for each translation feature) to predict the translation quality of each candidate translation. The system may then select a candidate translation with a higher translation quality as the final translation text. Clearly, the goal of the traditional machine translation method is to improve the linguistic accuracy of the translation result.

In practical application, there are many possible translations when translating text, and from a natural language perspective each translation result is correct. However, different translation results may influence user behavior in different ways depending on the particular scenario. For example, if a user inputs a query word “Hat” on a multilingual e-commerce website, the system will retrieve merchandise information associated with the word “ [symbol] ” in a Chinese language-based merchandise database. The system may translate each retrieved result from Chinese to English for the user to view. Assuming that the original Chinese text is “ [symbol] ”, there are two translation texts in English, which are “Red Hat” and “Red Cap”. These two translation texts are correct from a language perspective, without considering a specific scenario. However, if the query word is “Hat”, a user in an e-commerce scenario may prefer to click on the translation text “Red Hat” which is consistent with the user's query. This example indicates that different translation results in different scenarios may influence user behavior differently. In other words, the evaluation of translation quality may not only include linguistic accuracy, but also include local objectives associated with application scenarios.

In summary, current machine translation approaches do not consider specific application scenarios. When there is a specific application scenario, current machine translation approaches may result in translation results that have poor translation quality and fail to achieve local objectives, which negatively affects user experience. Therefore, a better approach to machine translation that accounts for specific application scenarios is desired.

### SUMMARY

One embodiment of the present disclosure provides a system for statistics-based machine translation. During operation, the system may obtain at least one text to be translated and localized information. The system may decode the text to be translated. The system may then generate a plurality of candidate translations for the text to be translated. For each candidate translation of the plurality of candidate translations, the system may obtain linguistic translation features according to the text to be translated and the candidate translation. The system may extract localized translation features according to the localized information. The system may then apply a translation quality prediction model to calculate translation quality scores for the plurality of candidate translations according to the linguistic translation features and the localized translation features. The system may select a predetermined number of candidate translations with highest translation quality scores as translations of the text to be translated.

### BRIEF DESCRIPTION OF THE DRAWINGS

The accompanying drawings described herein are used for further understanding the present application and constitute a part of the present application, and the schematic embodiments of the present application and the descriptions thereof are used for interpreting the present application, rather than improperly limiting the present application. In which:

FIG. 1 presents a schematic diagram illustrating an exemplary multilingual website, in accordance with an embodiment of the present invention.

FIG. 2 presents a schematic diagram illustrating exemplary machine translation feature optimizing based on search conversion rates, in accordance with an embodiment of the present invention.

FIG. 3 presents a flowchart illustrating an exemplary process for statistics-based machine translation, in accordance with an embodiment of the present invention.

FIG. 4 presents a flowchart illustrating an exemplary process for generating a translation quality prediction model in a statistics-based machine translation method, in accordance with an embodiment of the present invention.

FIG. 5 presents a flowchart illustrating an exemplary process for identifying noisy historical translation records associated with user behavior, in accordance with an embodiment of the present invention.

FIG. 6 presents a schematic diagram illustrating an exemplary apparatus for statistics-based machine translation, in accordance with an embodiment of the present invention.

FIG. 7 presents a schematic diagram illustrating an exemplary apparatus for statistics-based machine translation with a training module, in accordance with an embodiment of the present invention.

FIG. 8 presents a schematic diagram illustrating an exemplary electronic device for statistics-based machine translation, in accordance with an embodiment of the present invention.

FIG. 9 presents a flowchart illustrating an exemplary process for generating a translation quality prediction model, in accordance with an embodiment of the present invention.

FIG. 10 presents a schematic diagram illustrating an exemplary apparatus for generating a translation quality prediction model, in accordance with an embodiment of the present invention.

FIG. 11 presents a schematic diagram illustrating an exemplary server for statistics-based machine translation, in accordance with an embodiment of the present application.

### DETAILED DESCRIPTION OF EMBODIMENTS

Embodiments of the present invention solve the problem of improving machine translations by generating a translation quality prediction model and applying the translation quality prediction model to predict the quality of translations for different scenarios. A statistics-based machine translation system may generate and apply a translation quality prediction model that is trained on historical translation records. The historical translation records contain information describing how past users using various queries in different application scenarios responded to translations when browsing a multilingual e-commerce website. The translation quality prediction model learns, for example, which translations resulted in purchases and/or clicks from past users for specific queries. The translation quality prediction model may then predict the quality of candidate translations for merchandise names or descriptions when responding to a query from a user. The statistics-based machine translation system may choose the candidate translations with the highest predicted quality scores for presentation to the user, thereby resulting in a higher click-through rate and a greater number of purchases.

The statistics-based machine translation method disclosed herein considers actual localized features and localized translation features when estimating translation quality for candidate translations. Actual localized features refers to the local aspects associated with the translations. Localized translation features refers to a group of machine learning features that are related to localized scenarios, such as application scenario features, and features associated with user attributes and behavior. Using specific localized data and different translation quality prediction models in different scenarios (e.g., different feature weights for different scenarios), the system can not only obtain correct language translation results, but also satisfy local objectives.

### Exemplary Multilingual Website

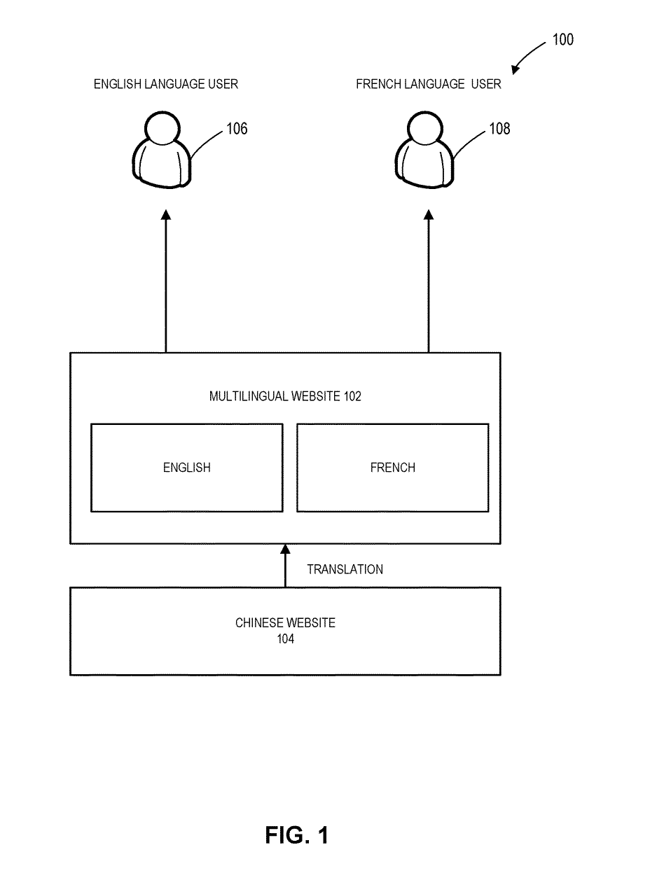

FIG. 1 presents a schematic diagram 100 illustrating an exemplary multilingual website 102 with Chinese as the native language, in accordance with an embodiment of the present invention. Multilingual website 102 translates a Chinese website 104 to English and French in order to provide service to a English language user 106 and a French language user 108, respectively. English language user 106 may perform searches using the English language and view search results, such a merchandise names and descriptions, translated to English from Chinese. French language user 108 may perform searches using the French language and view search results translated from Chinese to French. Chinese website 104 may store merchandise names and descriptions in Chinese. This disclosure describes how to improve the accuracy and acceptance of translations by learning from past user responses (e.g., such as clicks and purchases) to translated terms.

### Machine Translation Feature Optimizing Based on Search Conversion Rate

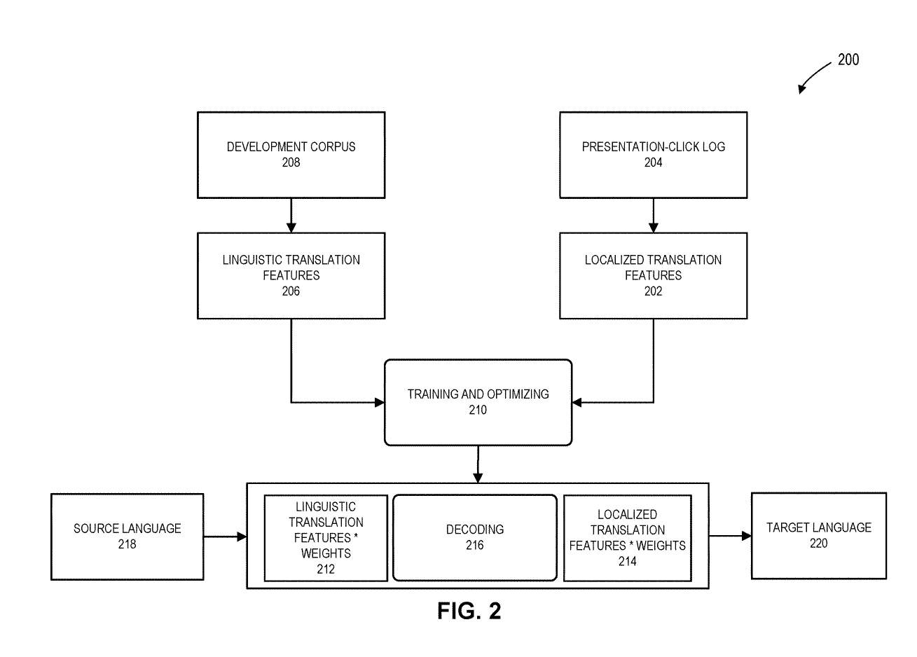

FIG. 2 presents a schematic diagram 200 illustrating exemplary machine translation feature optimizing based on search conversion rates, in accordance with an embodiment of the present invention. A statistics-based machine translation system may extract localized translation features 202 from a presentation-click log 204 and extract linguistic translation features 206 from a development corpus 208. Presentation-click log 204 may store localized processing results indicating whether past users clicked on particular translations or made purchases based on the translations when viewing search results. In some embodiments, development corpus 208 may include original text and translations derived from the original text.

Localized translation features 202 may include, for example, one of application scenario features, user static attributes features, and user historical behavior features. Examples of application scenario features may include whether a translation in a search scenario includes query words expressed in a target language and the position of query words in translation text. Examples of user static attributes features may include gender, age, address, and hobbies. Examples of user historical behavior features may include clicking behavior, collecting behavior, and language preference. Linguistic translation features may include translation features of traditional machine translation, such as probability of phrase translation from original text to translation text. The system may determine linguistic translation features based on computations associated with original text in a native language and translation text.

The system may combine the features and generate training samples to train a translation quality prediction model. The system may train and optimize 210 the translation quality prediction model based on input that includes presentation-click data. Such data indicates how past users responded to translations, e.g., whether a user clicked on or purchased an item based on a presented translation. The translation quality prediction model can be, for example, a logistic regression model, a support vector machine (SVM) model, or gradient boosted decision trees (GBDT).

The system can train and optimize a transition quality prediction model using training samples. The system may train a translation quality prediction model using linguistic translation features 206 and localized translation features 202. The system may determine weights for linguistic translation features 212 and weights for localized translation features 214 according to a formula for determining optimal model parameters based on a maximum likelihood method. For example, the system may assign weight values so as to maximize the probability of user clicks on translation text.

The system may generate candidate translations using text to be translated such as merchandise item names and/or descriptions obtained from a merchandise database. The system may decode 216 text to be translated expressed in a source language 218, create multiple translations, and select the best translations in the target language 220 according to the translation quality prediction model. Different target languages may be associated with different translation quality prediction models with different translation features and feature weights.

In some embodiments, the system may generate translation rules by learning from examples in a parallel text corpus that stores text placed alongside one or more translations. The system may generate the candidate translations using the translation rules and apply the translation quality prediction model to select from the candidate translations.

### Exemplary Process for Statistics-Based Machine Translation

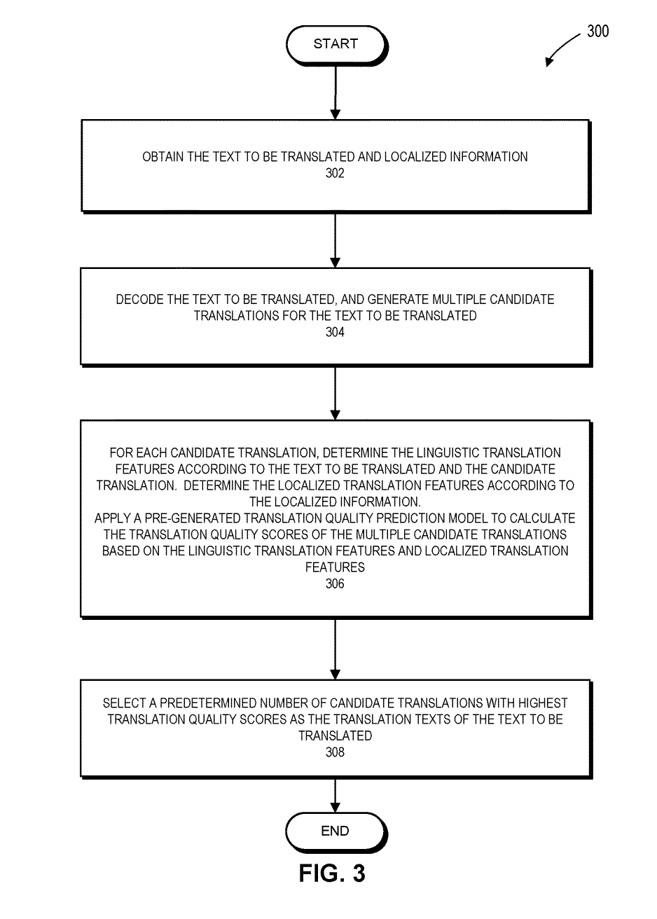

FIG. 3 presents a flowchart illustrating an exemplary process 300 for statistics-based machine translation, in accordance with an embodiment of the present invention. During operation, the system may initially obtain the text to be translated and localized information (operation 302). The localized information may include at least one of application scenario information, user static attributes information, and user historical behavior information. The application scenario information may include specific information in different application scenarios, such as query words expressed in a target language and entered by a user in a search scenario. The user static attributes information may include basic personal information of the user, such as gender, age, address, hobbies, and interests. The user historical behavior information may include a user's historical behavior and historical behavior preferences, such as clicking behavior, collecting behavior, purchase behavior, language preference, category preference and product brand preference.

In some embodiments, the statistics-based machine translation method considers actual localized features and localized translation features when evaluating the translation quality of candidate translations. The system may therefore need to obtain localized information first. The system may save the user static attributes information and the user historical behavior information in advance in a text file or database file format in a local computer (or other computers). The different save locations and save formats are variations in embodiments of the present invention and other embodiments may include different save locations and formats.

The system may use statistics-based machine translation in a search scenario for a multilingual e-commerce website. Under this scenario, the translation quality score may be indicative of the click-through rate for the candidate translations as search results. The localized information obtained in a search scenario may include application scenario information.

In an embodiment, the application scenario information includes a query expressed in the target language. The target language refers to the language of the translation text (e.g., the language of the translation result). The system may obtain the text to be translated in a search scenario by performing the following operations: 1) Obtain the query expressed in the target language as input by the user; 2) Translate the query expressed in the target language to a query expressed in a source language. The source language refers to the language of the text to be translated; 3) Retrieve the text to be translated according to the query expressed in the source language.

1) Obtain the query expressed in the target language as input by the user.

In a search scenario of the multilingual e-commerce website, the query input by the user is expressed in the target language, and the user examines the retrieved results expressed in the target language.

2) Translate the words of the query expressed in the target language to words of a query expressed in the source language.

The merchandise information stored in the background database of the multilingual e-commerce website is often expressed in only one language, e.g., the merchandise information may be expressed in the source language. For example, the merchandise information may be expressed in a source language which is Chinese. In order to retrieve information regarding merchandise that satisfies the query, the system may first translate the query words expressed in the target language (e.g., English) to query words expressed in the source language (e.g., Chinese).

3) Retrieve the text to be translated according to the query expressed in the source language.

After translating the query to the source language, the system can search for merchandise that satisfies the query in a merchandise database, and the system can translate the merchandise information from the search results to the target language. For example, if the user inputs the query “Hat” on the multilingual e-commerce website, after the system retrieves the merchandise information associated with the word “ [symbol] ” from the Chinese-language merchandise database, the system may translate each retrieved result from Chinese to English for the user to view.

After the system obtains the text to be translated and the localized information, the system may perform the next operation of decoding the text to be translated.

The system may decode (e.g., parse) the text to be translated, and generate multiple candidate translations for the text to be translated (operation 304).

The system decodes the text to be translated to generate the candidate translations according to pre-generated translation rules. The system generates the translation rules in advance by learning from a parallel text corpus. Parallel text is text that is placed alongside one or more translations. The translation rules are the basic transformation units for the machine translation process. The process for training and generating the translation rules from the parallel text corpus mainly includes these three stages: 1) data preprocessing; 2) word alignment and 3) phrase extraction. In practical application, the translation rules may have phrases as the basic translation unit without including syntax information, and the translation rules may also include syntax information obtained by modeling the translation model based on syntactic structure. Note that the different modes of translation rules described above are variations in embodiments of the present invention, and different embodiments may include other variations.

In practical application, the system may apply the Cocke-Younger-Kasami (CYK) decoding technique, stack-based decoding technique, or shift-reduce decoding technique to decode the text to be translated. The decoding techniques have their own advantages and disadvantages in terms of translation performance and decoding speed. The stack-based decoding technique and CYK decoding technique typically have a higher translation performance with a slower decoding speed. The shift-reduce decoding technique often has a lower translation performance with a higher decoding speed. The decoding methods are variations in different embodiments of the present invention and other embodiments may use different decoding methods.

For each candidate translation, the system may determine the linguistic translation features according to the text to be translated and the candidate translation. The system may also determine the localized translation features according to the localized information. The system may apply a pre-generated translation quality prediction model to calculate the translation quality scores of the multiple candidate translations based on the linguistic translation features and localized translation features (operation 306). After the system generates the candidate translations for the text to be translated, the system can generate the translation quality scores of the candidate translations according to the translation features of the candidate translations and a pre-generated translation quality predication model.

The system may extract translation features before applying the pre-generated translation quality predication model to predict the translation quality scores. The translation features may include statistical information affecting the translation quality of the candidate translations. The two types of translation features are linguistic (e.g., language-related) translation features and localized translation features. The system may obtain linguistic translation features based on computations associated with the text to be translated and the candidate translations. The system may extract localized translation features from the localized information obtained according to operation 302.

The linguistic translation features may include translation features of traditional machine translation. This includes at least one of probability of phrase translation from text to be translated to candidate translation, probability of phrase translation from candidate translation to text to be translated, probability of word translation from text to be translated to candidate translation, probability of word translation from candidate translation to text to be translated, probability of candidate translation for a sentence, and classification probabilities associated with reordering and not reordering the text to be translated and candidate translation.

The localized translation features may include at least one of application scenario features, user static attributes features, and user historical behavior features. The system may extract application scenario features, user static attributes features, and user historical behavior features from application scenario data, user static attributes data and user historical behavior data, respectively. Examples of application scenario features may include whether a candidate translation in a search scenario includes query words expressed in the target language, position of query words in the candidate translation, whether the candidate translation includes any untranslated terms, and/or the number of terms included in the candidate translation. Examples of user static attributes features may include gender, age, address, and hobbies. Examples of user historical behavior features may include clicking behavior, collecting behavior, buying behavior, language preferences, category preferences, and product brand preferences.

The system may use a pre-generated translation quality prediction model to predict the translation quality of each candidate translation. The system may order each candidate translation for selection by a user according to the predicted value of the translation quality. Generally, a larger predicted value of translation quality indicates that the candidate translation has a higher translation quality. To implement the method provided by the embodiment of the present invention, the system may generate the translation quality prediction model first.

The system may apply a machine learning technique to generate the translation quality prediction model from a set of historical translation records labeled with localized processing results. Each historical translation record in the set includes information associated with one machine translation, such as an original text, a translation text, and localized information. Localized information in the historical translation record is the same concept as localized information in operation 302, e.g., the historical localized information referred to when translating from original text to translation text. Localized processing results may include local objectives, and are related to the translation quality of translation text. Translation quality determines the localized processing results for a respective translation text. When the set of historical translation records is derived from a search scenario, the localized processing results may indicate whether a translation text is clicked on when the translation text is used as a search result. The localized processing results may also indicate whether merchandise referred to in a translation text is purchased when the translation text that refers to the merchandise is included in a search result.

After the system calculates the predicted value of the translation quality score for each candidate translation, the system may select a predetermined number of candidate translations with highest translation quality scores as the translation texts of the text to be translated (operation 308). The system may provide the selected candidate translations with highest translation quality scores to a user for selection. For example, the system may select a single candidate translation with the highest translation quality score and provide that selected candidate translation to the user.

### Generating a Translation Quality Prediction Model

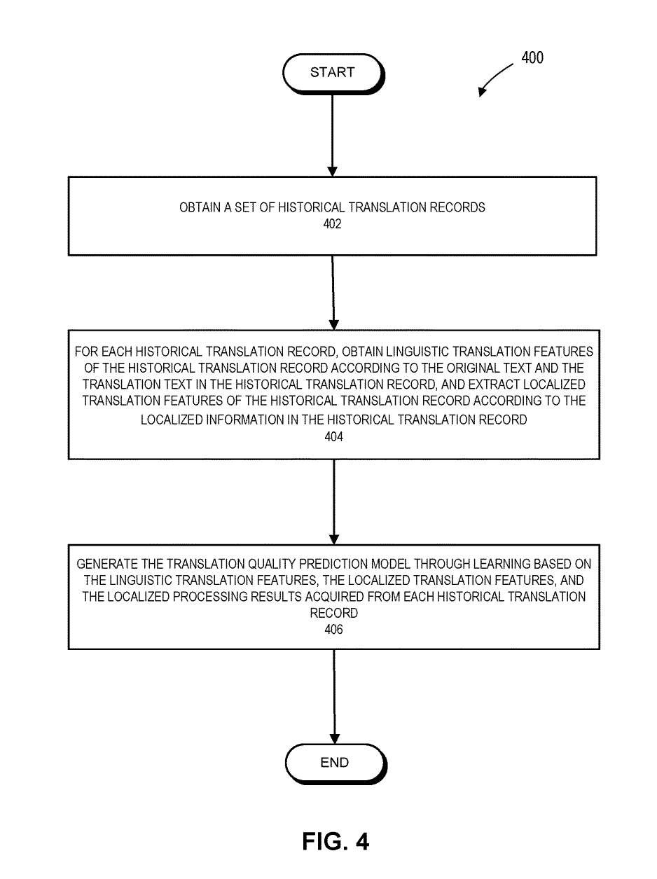

FIG. 4 presents a flowchart illustrating an exemplary process 400 for generating a translation quality prediction model in a statistics-based machine translation method, in accordance with an embodiment of the present invention. The system may apply a machine learning technique to generate the translation quality prediction model by learning from a set of historical translation records labeled with localized processing results as described below.

During operation, the system may obtain the set of historical translation records (operation 402). The system may generate the translation quality prediction model according to a training set, which is a vector set composed of translation features and localized processing results. To generate the training set, the system first obtains the set of historical translation records.

The historical translation records may be stored in a business processing log. The system may generate the set of historical translation records according to a prestored business processing log that stores business data as well as translation-related log data. The business processing log may be a presentation-click log generated in a search scenario of a multilingual e-commerce website. Such a presentation-click log may store data indicating whether merchandise information is clicked on when the merchandise information is presented to a user. Table 1 illustrates an exemplary format for the log data.

TABLE 1
Format of Log Data

| S/N | Name | Description |
|---|---|---|
| 1 | Query | Search term |
| 2 | Offer_ID | Merchandise identifier |
| 3 | Title | Merchandise name |
| 4 | Rank | Display position of |
| | | presented merchandise |
| 5 | Is_Click | Whether the merchandise |
| | | information is clicked on |
| . . . | . . . | . . . |

As presented in Table 1, the presentation-click log may include the following fields: Query, Offer_ID (identifier of presented merchandise), Title (name of merchandise presented to user), Rank (display position of presented merchandise), and Is_Click (whether the presented merchandise information is clicked by a user, e.g., localized processing result). Various data can be obtained from the historical translation record, including 1) the merchandise name expressed in the source language which can be obtained through Offer_ID (merchandise identifier), e.g., original text in the historical translation record; 2) Title (merchandise name), e.g., translation text in the historical translation record; 3) Query, e.g., localized information in the historical translation record; and 4) Is_Click (whether the user clicks on the merchandise information), e.g., localized processing result.

In practical application, the business processing log may contain some noisy data, e.g., noisy historical translation records. Noisy historical translation records may include noisy historical translation records not associated with user behavior or noisy historical translation records associated with user behavior. Noisy historical translation records not associated with user behavior may include noisy historical translation records generated from activities such as web crawler and internet fraud in search scenarios. Noisy historical translation records associated with user behavior are generated based on user activity. For example, the system typically displays search results satisfying a query in a retrieved results listing webpage. A user may perform operations on the retrieved results (e.g., localized processing results) in a manner that is associated with the displayed position of the retrieved results. For example, when the user quickly pulls the retrieved results listing webpage from top to bottom, the retrieved results located in the middle of the result list are not actually viewed by the user. Such portions of the retrieved results are not actually presented, and are not clicked on by the user. The system may record the unviewed portions of the retrieved results in the business processing log, and the corresponding localized processing result is “not clicked on”. These retrieved results recorded in the business processing log are typically noisy data rather than useful data. Such data may be called noisy historical translation records associated with user behavior. If the system does not eliminate the above two types of noisy historical translation records, the quality of the set of historical translation records as training samples decreases, resulting in reduced accuracy for the generated translation quality prediction model.

Therefore, before training the translation quality prediction model using the set of historical translation records labeled with the localized processing results, the system may apply a preset noisy data filtering technique to eliminate the noisy historical translation records from the set of historical translation records. The system can improve the data quality of training samples through this operation, thereby increasing the accuracy of the translation quality prediction model.

For the noisy historical translation records not associated with user behavior, the system may apply a noisy data filtering technique including anti-fraud and anti-crawler techniques according to the cause of the noisy data. For the noisy historical translation records associated with user behavior from a search scenario, the system may preset the noisy data filtering technique to eliminate the noisy historical translation records from the set of historical translation records as follows: 1) identify the noisy historical translation records associated with user behavior according to a preset browsing probability prediction model; and 2) delete the historical translation records identified as noisy historical translation records associated with user behavior.

1) Identify the noisy historical translation records associated with user behavior according to the preset browsing probability prediction model.

In a search scenario, a user may perform operations with the results that are retrieved through search. The user's operations performed on the retrieved results are not only affected by the quality of the translation of merchandise names, but also the display position of the translation text. For example, users are generally used to browsing retrieved results from top to bottom and from left to right. As a result, the translation text towards the top of a webpage may be more likely to be selected by the user, while the possibility of the user selecting the translation text towards the bottom may gradually decrease. For this purpose, the system may use a probability statistical model to model and predict user behavior, simulate users' browsing modes, and eliminate the impact of display position on the localized processing results. The system may thereby improve the quality of training data and increase the accuracy of the translation quality prediction model.

Embodiments of present invention may perform a normalization computation on the arrangement positions of retrieved results according to a preset browsing probability prediction model, to eliminate the effect of arrangement position on the localized processing results. Common browsing probability prediction models include examples such as the Dependent Click Model (DCM) and the Bayesian Browsing Model (BBM). DCM is presented as an example below in expression (1):

$$\{ \begin{matrix}P ( {E}_{i + 1} = 1 \vert {E}_{i} = 1 , {C}_{i} = 1 ) = {λ}_{i} \\ P ( {E}_{i + 1} = 1 \vert {E}_{i} = 1 , {C}_{i} = 0 ) = 1\end{matrix} \qquad ( 1 )$$

In the expression above, E indicates whether a user performs “examination” (e.g., examination is when a user is viewing and/or browsing) and C indicates whether a user performs “click” (e.g., clicking by the user). The physical meaning of the model is as follows: when a user examines and clicks on an i^{th} position, then the probability of the user examining the (i+1)^{th} position is λᵢ. When the user examines but does not click on the i^{th} position, then the probability of the user examining the (i+1)^{th} position is 1. The model expression (1) indicates that the DCM is quite hypothetical, and performing normalization processing on displayed positions of retrieved data based on such a model will certainly result in errors.

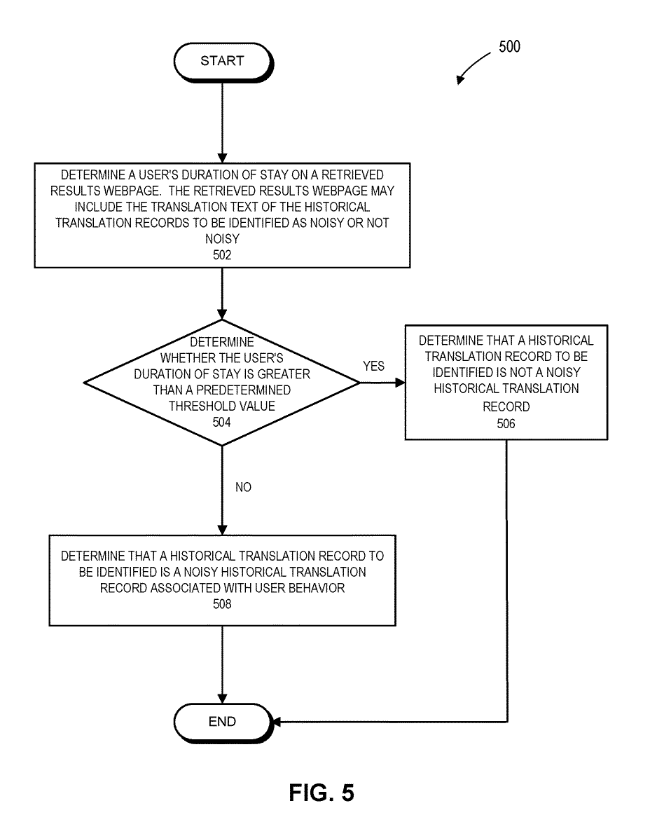

In some embodiments, the system may use a browsing probability prediction model to determine whether retrieved results are actually browsed by a user according to the user's duration of stay on a webpage of retrieved results (e.g., the user's duration of time in viewing the webpage). Using this model, the system can avoid browsing mode assumptions, thereby increasing the browsing probability prediction accuracy. FIG. 5 presents details of an exemplary process for identifying noisy historical translation records associated with user behavior by applying a browsing probability prediction model.

2) Delete the historical translation records identified as noisy historical translation records associated with user behavior.

After the system identifies the noisy historical translation records associated with user behavior according to the browsing probability prediction model, the system may delete the portions of noisy data, so as to improve the quality of training data and improve the translation quality prediction model.

After preparing the set of historical translation records, the system may extract the linguistic translation features and localized translation features from each historical translation record.

For each historical translation record, the system may obtain linguistic translation features of the historical translation record according to the original text and the translation text in the historical translation record, and extract localized translation features of the historical translation record according to the localized information in the historical translation record (operation 404). The linguistic translation features, the localized translation features, and the localized information are similar to that described with respect to FIG. 3 (e.g., operation 306).

Using machine learning techniques, the system may generate the translation quality prediction model through learning based on the linguistic translation features, the localized translation features, and the localized processing results acquired from each historical translation record (operation 406).

The system can train the translation quality prediction model using training samples. A vector set that includes the translation features and localized processing results determined in operations 404-406 may serve as a training set. The training of the prediction model is complete when the system achieves an optimization objective.

Embodiments of the present invention may utilize machine learning techniques such as logistic regression, SVM, and iterative decision tree to generate the translation quality prediction model. The accuracy of a translation quality prediction model may vary based on the technique used to generate the model, and computation complexity may also vary with technique. In practical application, the system may select any machine learning technique to generate the translation quality prediction model according to the demands of the specific application.

In some embodiments, the system may utilize a logistic regression technique to train and generate the translation quality prediction model. That is, the prediction model is a logistic regression model. For a translation quality prediction model generated using logistic regression, each translation feature has a weight, and the system may use these weights to control the influence different translation features have on the translation quality of candidate translations. The process for training the translation quality prediction model may include adjusting feature weights. Based on each translation feature extracted in operation 404, the system may use the maximum likelihood method to determine the weight of each parameter in the translation quality prediction model. The formula for determining optimum model parameters based on the maximum likelihood method is as follows:

$${max}_{w} \{ {\prod }_{k} P ( {y}_{k} \vert w , {fea}_{k} ) \}$$

In the above formula, P(yₖ|w, feaₖ) represents the click-through rate from search and yₖ represents localized processing results of a historical translation record k. In a search scenario, localized processing results may include discrete classification data that indicates whether translation texts have been clicked on or not. If the user clicks the translation text in historical translation record k at the first presentation (e.g., user views and clicks the translation text), then yₖ=1. If the user does not click the translation text in historical translation record k at the first presentation, then yₖ=0. w represents a weight vector that includes the feature weight of each translation feature in the translation quality prediction model and feaₖ represents translation features extracted from historical translation record k. The meaning of the expression is as follows: the system adjusts the feature weight of each translation feature in the translation quality prediction model on the basis that the optimization objective is the maximum product of probabilities of correct localized processing results for each historical translation record.

In a product search scenario on a multi-language e-commerce website, the system may use the logistic regression model to calculate a predicted click-through rate for searches, and the formula for the generated translation quality prediction model is as follows:

$$P ( {y}_{k} \vert w , {fea}_{k} ) = \frac{1}{1 + {e}^{- ( {Σ}_{i} {w}_{i} \cdot {f}_{i} + {Σ}_{j} {w}_{j} \cdot {f}_{j} )}}$$

In the above formula, fᵢ represents linguistic translation features and fⱼ represents localized translation features.

The system performs the operations described above to train and generate the translation quality prediction model. Different target languages correspond to different translation quality prediction models, and different translation quality prediction models may also have different translation features and feature weights. When translating text, the system may use a translation quality prediction model corresponding to a target language to predict translation quality scores of candidate translations. For example, translation quality prediction models with English and Russian as target languages are different from each another. Specifically, localized translation features in the translation quality prediction model for English may include, for example, “whether the translation text includes the query”. Localized translation features in the translation quality prediction model for Russian may include, for example, “whether the query is present in an earlier part of the translation text”. The different localized features associated with different languages may be the result of the habits of different language users. In practical application, the system may need to generate the translation quality prediction model corresponding to the target language based on the set of historical translation records of the target language. For instance, the system may generate the translation quality prediction model corresponding to English based on a set of historical translation records with translation texts in English. The system may also generate a translation quality prediction model corresponding to Russian based on a set of historical translation records with translation texts in Russian.

After the system trains and generates the translation quality prediction model, the system may use the translation quality prediction model to calculate the translation quality score of each candidate translation. Specifically, the system may input each extracted translation feature as a parameter into the translation quality prediction model. The system may use the translation quality prediction model to calculate the predicted value of the translation quality score of the candidate translations.

The system may then select a predetermined number (e.g., quantity) of candidate translations with highest translation quality scores to be the translation texts of the text to be translated.

Identifying Noisy Historical Translation Records Associated with User Behavior

FIG. 5 presents a flowchart illustrating an exemplary process 500 for identifying noisy historical translation records associated with user behavior, in accordance with an embodiment of the present invention. The system may identify the noisy historical translation records associated with user behavior according to a preset browsing probability prediction model as described below.

The system may determine a user's duration of stay on a retrieved results webpage, and the retrieved results webpage may include the translation text of the historical translation records to be identified as noisy or not noisy (operation 502). The duration of stay is the length of time that the user views the webpage with retrieved results. The system may identify the associated historical translation records as either noisy or not noisy.

The historical translation records to be identified may include information such as the original text and the translation text. For each historical translation record to be identified, the system may determine whether the user actually browsed the translation text in the historical translation record according to the user's duration of stay on a webpage of retrieved results that includes the translation text. The system may record in a business processing log the user's duration of stay on each webpage of retrieved results.

The system may determine whether the user's duration of stay is greater than a predetermined threshold value (operation 504). The system may determine the predetermined threshold value based on analyzing a large quantity of statistical data. In response to determining that the duration of stay is greater than the predetermined threshold value, the system may determine that a historical translation record to be identified is not a noisy historical translation record (operation 506). In response to determining that the duration of stay is not greater than the predetermined threshold value, the system may determine that a historical translation record to be identified is a noisy historical translation record associated with user behavior (operation 508).

This model is presented in expression (2):

$$P ( {E}_{i + 1} = 1 \vert {E}_{i} = 1 , t ) = \{ \begin{matrix}1 , t > T \\ 0 , t < T\end{matrix} \qquad ( 2 )$$

In expression (2), t indicates the user's duration of stay, and T indicates the threshold stay duration value. If t>T, this indicates that the user's stay on the webpage of retrieved results is of sufficient duration, and that the user indeed browses the retrieved results as listed on the webpage. Otherwise, the retrieved results as listed on the webpage are actually not presented or exposed to the user. The localized processing results corresponding to such retrieved results are considered noisy historical translation records. For example, when a user quickly pulls a webpage containing a retrieved result list from top to bottom, the retrieved results in the middle section are not viewed by the user. That portion of retrieved results are not considered actually presented or exposed to the user, and the system identifies as noisy any historical translation records associated with that portion of retrieved results.

### Apparatus for Statistics-Based Machine Translation

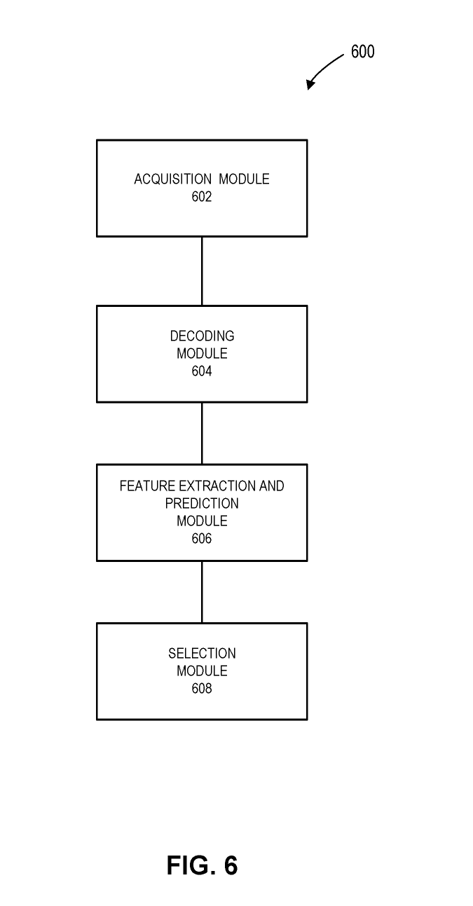

FIG. 6 presents a schematic diagram illustrating an exemplary apparatus 600 for statistics-based machine translation, in accordance with an embodiment of the present invention. A statistics-based machine translation apparatus may include an acquisition module 602, a decoding module 604, a feature extraction and prediction module 606, and a selection module 608.

Acquisition module 602 may obtain text to be translated and localized information.

Decoding module 604 may decode text to be translated, and generate multiple candidate translations for the text to be translated.

Feature extraction and prediction module 606 may, for each candidate translation, obtain linguistic translation features according to the text to be translated and candidate translations and obtain localized translation features according to the localized information. Feature extraction and prediction module 606 may use a pre-generated translation quality prediction model to calculate translation quality scores of the multiple candidate translations according to the linguistic translation features and localized translation features.

Selection module 608 may select a predetermined number of candidate translations with highest translation quality scores as translation texts of the text to be translated.

Optionally, the localized information may include at least one of application scenario information, user static attributes information, and user historical behavior information. The localized translation features may include at least one of application scenario features, user static attributes features, and user historical behavior features.

The translation quality scores may influence the click-through rate for search when the candidate translations are used as search results. That is, the higher the translation quality score, the greater the potential click-through rate. The application scenario information may include query words expressed in a target language. The application scenario features may include at least one of the following: whether a candidate translation includes the query words, the position of the query words in the candidate translation, whether the candidate translation includes words not translated, and the number of words included in the candidate translation. Target language refers to a language in which the candidate translations are expressed.

Acquisition module 602 may include an acquisition submodule, a translation submodule, and a retrieval submodule.

The acquisition submodule may obtain a query expressed in the target language as input by the user.

The translation submodule may translate the query expressed in the target language into a query expressed in a source language. The source language refers to a language in which text to be translated is expressed.

The retrieval submodule may retrieve the text to be translated according to the query expressed in the source language.

Apparatus for Statistics-Based Machine Translation with a Training Module

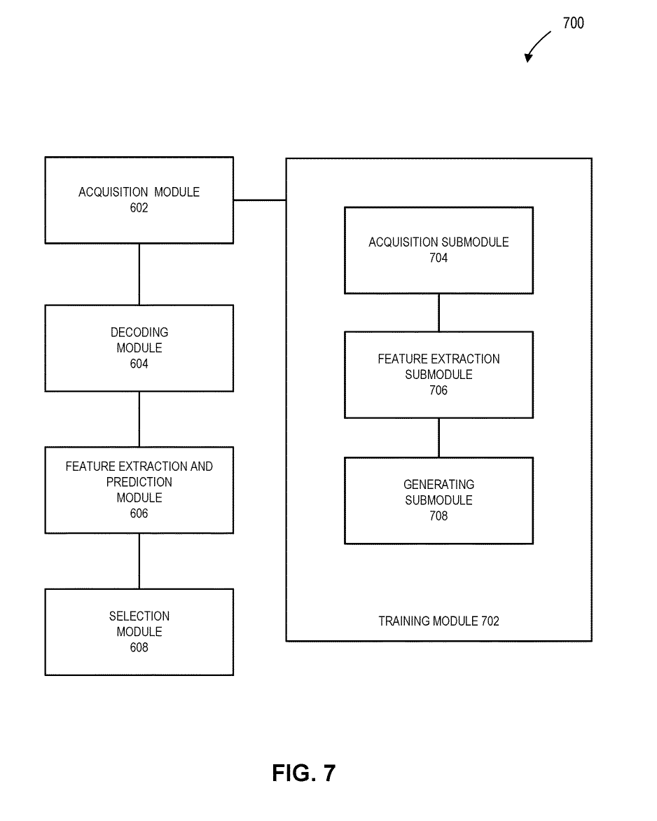

FIG. 7 presents a schematic diagram illustrating an exemplary apparatus 700 for statistics-based machine translation with a training module, in accordance with an embodiment of the present invention. Apparatus 700 may include a training module 702, an acquisition submodule 704, a feature extraction submodule 706, and a generating submodule 708.

Training module 702 may, by applying machine learning techniques, train a translation quality prediction model using a set of historical translation records labeled with localized processing results. The historical translation records may include original text, translation text, and localized information.

Training module 702 may include acquisition submodule 704, feature extraction submodule 706, and generating submodule 708.

Acquisition submodule 704 may obtain the set of historical translation records.

Feature extraction submodule 706 may, for each historical translation record, obtain linguistic translation features of the historical translation record according to the original text and the translation text in the historical translation record. Feature extraction submodule 706 may also extract localized translation features of the historical translation record according to the localized information in the historical translation record.

Generating submodule 708 may, through machine learning techniques, train and generate the translation quality prediction model according to the linguistic translation features, localized translation features, and localized processing results obtained from each historical translation record.

In addition, optional modules may include a data filtering module that eliminates noisy historical translation records from the set of historical translation records using a preset filtering technique.

Apparatus 700 may also include acquisition module 602, decoding module 604, feature extraction and prediction module 606, and selection module 608. These components correspond to the same components described with respect to FIG. 6.

### Electronic Device for Statistics-Based Machine Translation

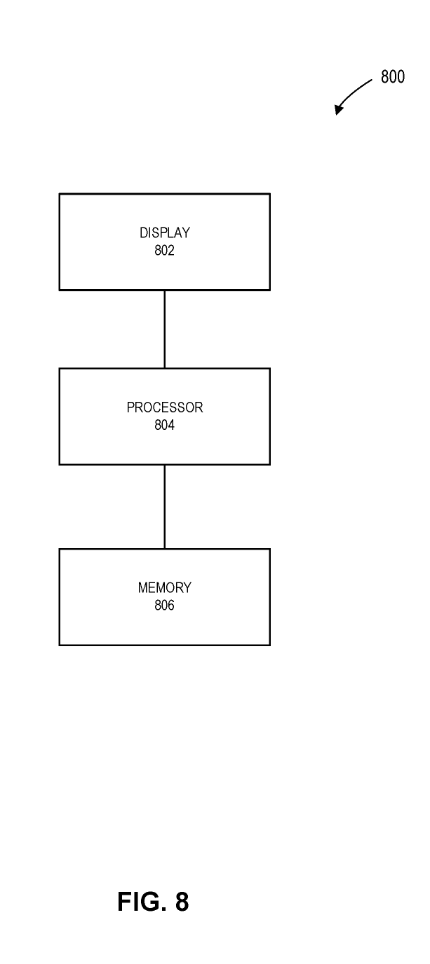

FIG. 8 presents a schematic diagram illustrating an exemplary electronic device 800 for statistics-based machine translation, in accordance with an embodiment of the present invention. Electronic device 800 may include a display 802, a processor 804, and a memory 806. Memory 806 may be configured to store the code for a statistics-based machine translation device.

The device may execute the following operations using processor 804: obtain the text to be translated and localized information; decode the text to be translated, and generate multiple candidate translations for the text to be translated; for each candidate translation, obtain the linguistic translation features based on the text to be translated and candidate translations; extract the localized translation features based on the localized information; use a pre-generated translation quality prediction model to calculate the translation quality scores of the candidate translations based on the linguistic translation features and the localized translation features; and select a predetermined number of candidate translations with highest translation quality scores as the translation texts of the text to be translated.

Since the system considers the actual localized features while assessing the translation quality of candidate translations, e.g., adding the localized translation features, the system provides translations that are not only linguistically accurate, but also satisfy local objectives. Furthermore, the translations provided by embodiments of the present invention are linguistically more accurate than translations provided by existing translation systems. Embodiments of the present invention effectively account for and analyze user input in scoring the candidate translations and selecting the best translations, thereby providing translations that are more accurate than existing systems. Since the system selects translations that users are historically more responsive to, it is clear that the selected translations are understandable and appealing to users. Because the translations are more accurate, embodiments of the present invention improve the user experience.

Note also that embodiments of the present invention eliminate the need for difficult and long online testing periods to understand the influence on user clicks for a new version of a machine translation system. One can use the techniques disclosed herein to test a new version of a machine translation system, instead of using online testing. The system can use the translation results from the new machine translation system to quickly compare and determine whether the new version of the machine translation system produces better quality translations that are more appealing to users.

The translation quality prediction model disclosed herein is acquired through machine learning based on a set of historical translation records (e.g., which may include the original text, the translation text, and localized information) labeled with localized processing results. Since the training objective is focused on actual localized processing objectives and based on not only linguistic translation features but also localized translation features, the result is the ability to generate a translation quality prediction model that is more suitable for actual localized features.

### Generating a Translation Quality Prediction Model

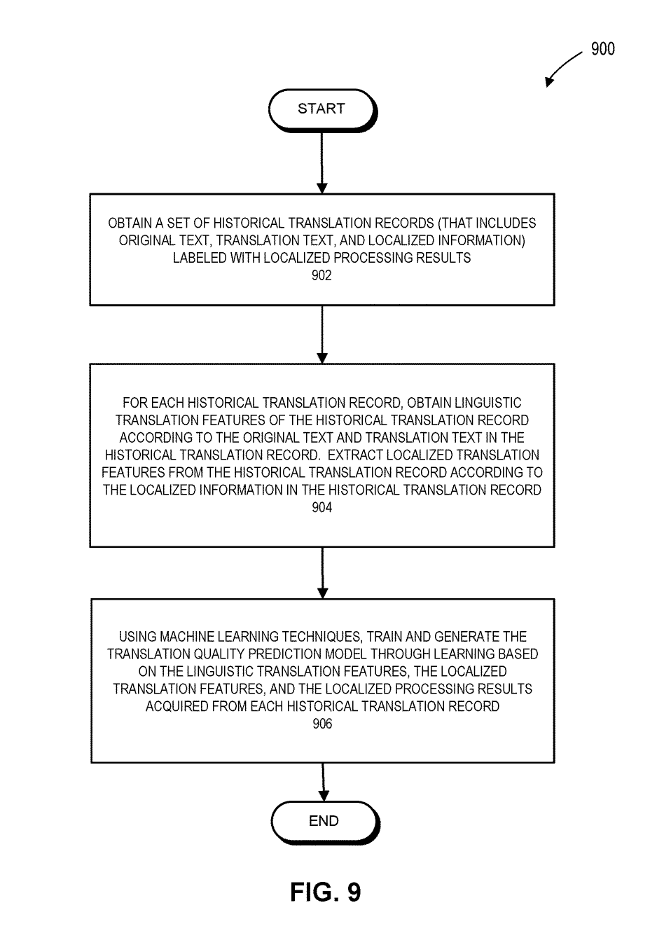

FIG. 9 presents a flowchart illustrating an exemplary process 900 for generating a translation quality prediction model, in accordance with an embodiment of the present invention. This embodiment corresponds to the generating of the translation quality prediction model in the statistics-based machine translation method, and the description is briefly presented below.

During operation, the system may initially obtain a set of historical translation records (that includes original text, translation text, and localized information) labeled with localized processing results (operation 902).

In an embodiment, localized information may include at least one of application scenario information, user static attributes information, and user historical behavior information. Application scenario information may include query words expressed in a target language. The system may derive the set of historical translation records from a search scenario. Localized processing results may indicate whether translation text is clicked on when used as a search result and whether merchandise identified by the translation text is purchased when included in a search result. Localized translation features may include at least one of the following: whether the translation text includes query words, where the query words are located in the translation text, whether the translation text includes words not translated, and the number of words included in the translation text. The target language is a language in which the translation text is expressed.

In an embodiment, the system may generate the set of historical translation records using a prestored business processing log storing localized log data as well as translation-related data. After the system obtains the set of historical translation records labeled with localized processing results, the system may eliminate noisy historical translation records from the set of historical translation records by using a preset filtering technique for noisy data.

For each historical translation record, the system may obtain linguistic translation features of the historical translation record according to the original text and translation text in the historical translation record (operation 904). The system may also extract localized translation features from the historical translation record according to the localized information in the historical translation record.

The linguistic translation features may include at least one of the following: probability of phrase translation from the original text to the translation text; probability of phrase translation from the translation text to the original text; probability of word translation from the original text to the translation text; probability of word translation from the translation text to the original text; sentence probability of the translation text, and classification probability for reordering or not reordering the original text and translation text.

Using machine learning techniques, the system may train and generate the translation quality prediction model through learning based on the linguistic translation features, the localized translation features, and the localized processing results acquired from each historical translation record (operation 906).

Embodiments of the present invention may utilize machine learning techniques such as logistic regression, SVM, and iterative decision tree to generate the translation quality prediction model. In an embodiment that uses logistic regression, the system may use the following optimization objective when generating the translation quality prediction model:

$${max}_{w} \{ {\prod }_{k} P ( {y}_{k} \vert w , {fea}_{k} ) \}$$

In the above formula, P(yₖ|w, feaₖ) represents the click-through rate from search and yₖ represents localized processing results of a historical translation record k. If a user clicks the translation text in historical translation record k at the first presentation, then yₖ=1. If the user does not click the translation text in historical translation record k at the first presentation, then yₖ=0. w represents a weight vector that includes the feature weight of each translation feature in the translation quality prediction model and feaₖ represents translation features extracted from historical translation record k.

Different target languages correspond to different translation quality prediction models, and the system generates the translation quality prediction model of a target language based on the set of historical translation records of the target language. The target language is the language in which the translation texts are expressed.

### Apparatus for Generating a Translation Quality Prediction Model

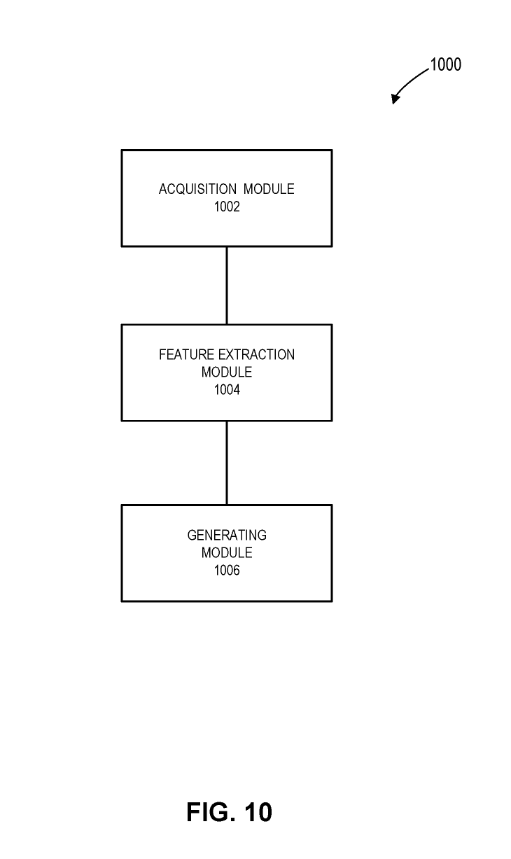

FIG. 10 presents a schematic diagram illustrating an exemplary apparatus 1000 for generating a translation quality prediction model, in accordance with an embodiment of the present invention. The apparatus may include an acquisition module 1002, a feature extraction module 1004, and a generating module 1006.

Acquisition module 1002 may obtain a set of historical translation records labeled with localized processing results. A historical translation record may include original text, translation text, and localized information.

Feature extraction module 1004 may, for each historical translation record, obtain linguistic translation features of the historical translation record according to the original text and translation text in the historical transaction translation record. Feature extraction module 1004 may also extract localized translation features from the historical translation record according to the localized information in the historical translation record.

Generating module 1006 may, using machine learning techniques, train and generate the translation quality prediction model through learning based on the linguistic translation features, localized translation features, and localized processing results acquired from each historical translation record. In some embodiments, the system may also generate test samples and optimize feature weights based on the results of applying the translation quality prediction model on the test samples. In addition, optional modules may include a data filtering module that eliminates noisy historical translation records from the set of historical translation records using a preset filtering technique for noisy data.

### Exemplary Embodiments

Embodiments of the present disclosure include a system for statistics-based machine translation. During operation, the system may obtain at least one text to be translated and localized information. The system may decode the text to be translated. The system may then generate a plurality of candidate translations for the text to be translated. For each candidate translation of the plurality of candidate translations, the system may obtain linguistic translation features according to the text to be translated and the candidate translation. The system may extract localized translation features according to the localized information. The system may then apply a translation quality prediction model to calculate translation quality scores for the plurality of candidate translations according to the linguistic translation features and the localized translation features. The system may select a predetermined number of candidate translations with highest translation quality scores as translations of the text to be translated.

In a variation on this embodiment, the localized information includes at least one of application scenario information, user static attributes information, and user historical behavior information. Also, the localized translation features may include at least one of application scenario features, user static attributes features, and user historical behavior features.

In a further variation, the system may apply the statistics-based machine translation method in a search scenario. The translation quality scores may indicate click-through rates for the plurality of candidate translations as search results. The application scenario information may include one or more query words expressed in a target language. The application scenario features may include at least one of whether a candidate translation includes the query words, a position of the query words in the candidate translation, whether the candidate translation includes any untranslated terms, and a number of terms included in the candidate translation. Furthermore, the target language is the language of the candidate translation.

In a variation on this embodiment, obtaining the text to be translated may further include obtaining a query expressed in a target language as input by a user. The system may also translate the query expressed in the target language to a query expressed in a source language. The system may retrieve the text to be translated according to the query expressed in the source language.

In a variation on this embodiment, the system may generate the translation quality prediction model through machine learning by training with a set of historical translation records labeled with localized processing results. Each historical translation record in the set may include an original text, a translation text, and one or more localized information.

In a further variation on this embodiment, the localized information may include at least one of application scenario information, user static attributes information, and user historical behavior information.

In a further variation, the system may derive the set of historical translation records from a search scenario. One or more localized processing results indicate whether the translation text is clicked on when the translation text is used as a search result, or whether merchandise mentioned in the translation text is purchased when the merchandise mentioned in the translation text is included in the search result. The application scenario information may include a query expressed in a target language, and the target language is the language of the translation text.

In a further variation, different target languages correspond to different translation quality prediction models. The system may also generate the translation quality prediction model of a target language based on a set of historical translation records of the target language. The target language is a language in which the translation text is expressed.

In a further variation, the system may apply a preset noisy data filtering technique to eliminate one or more noisy historical translation records from the set of historical translation records before generating the translation quality prediction model.

In a further variation, generating the translation quality prediction model through machine learning by training with the set of historical translation records labeled with localized processing results may further include obtaining the set of historical translation records. For each historical translation record of the set of historical translation records, the system may obtain linguistic translation features of the historical translation record according to the original text and the translation text in the historical translation record. The system may extract localized translation features of the historical translation record according to the localized information in the historical translation record. The system may use a machine learning technique to generate the translation quality prediction model according to the linguistic translation features, the localized translation features, and localized processing results acquired from each historical translation record.

### Exemplary Server

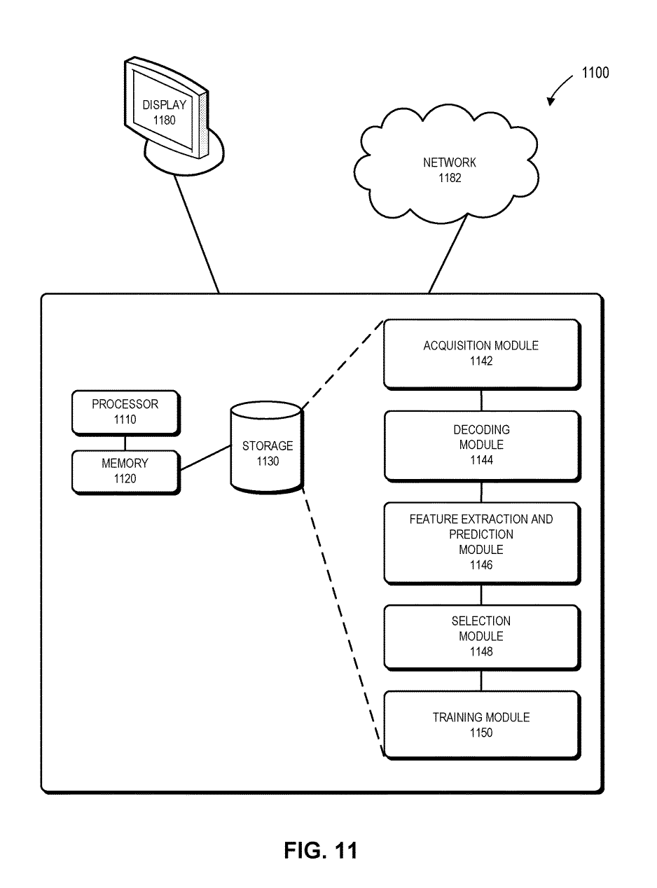

FIG. 11 presents a schematic diagram illustrating an exemplary server 1100 for statistics-based machine translation, in accordance with an embodiment of the present application. Server 1100 may include a processor 1110, a memory 1120, and a storage device 1130. Storage 1130 typically stores instructions that can be loaded into memory 1120 and executed by processor 1110 to perform the methods described above. In one embodiment, the instructions in storage 1130 can implement an acquisition module 1142, a decoding module 1144, a feature extraction and prediction module 1146, a selection module 1148, and a training module 1150 which can communicate with each other through various means.

In some embodiments, modules 1142-1150 can be partially or entirely implemented in hardware and can be part of processor 1110. Further, in some embodiments, the server may not include a separate processor and memory. Instead, in addition to performing their specific tasks, modules 1142-1150, either separately or in concert, may be part of special-purpose computation engines.

Storage 1130 stores programs to be executed by processor 1110. Specifically, storage 1130 stores a program that implements a server (e.g., application) for statistics-based machine translation. During operation, the application program can be loaded from storage 1130 into memory 1120 and executed by processor 1110. As a result, server 1100 can perform the functions described above. Server 1100 can further include an optional display 1180, and can be coupled via one or more network interfaces to a network 1182.

Acquisition module 1142 may obtain text to be translated and localized information.

Decoding module 1144 may decode text to be translated, and generate multiple candidate translations for the text to be translated.

Feature extraction and prediction module 1146 may, for each candidate translation, obtain linguistic translation features according to the text to be translated and candidate translations and obtain localized translation features according to the localized information. Feature extraction and prediction module 1146 may use a pre-generated translation quality prediction model to calculate translation quality scores of the multiple candidate translations according to linguistic translation features and localized translation features.

Selection module 1148 may select a predetermined number of candidate translations with highest translation quality scores as translation texts of the text to be translated.

Training module 1150 may, by applying machine learning techniques, train a translation quality prediction model using a set of historical translation records labeled with localized processing results. Training module 1150 may also include an acquisition submodule, a feature extraction submodule, and a generating submodule (not pictured). The acquisition submodule may obtain a set of historical translation records. The feature extraction submodule may, for each historical translation record, obtain linguistic translation features of the historical translation record according to the original text and the translation text in the historical translation record. The feature extraction submodule may also extract localized translation features of the historical translation record according to the localized information in the historical translation record.

The generating submodule may, through machine learning techniques, train and generate the translation quality prediction model according to linguistic translation features, localized translation features, and localized processing results obtained from each historical translation record.

Embodiments of the present invention may be implemented on various universal or dedicated computer system environments or configurations. For example, the computer systems may include personal computers, server computers, handheld or portable devices, tablet-type devices, multiprocessor systems, microprocessor-based systems, set-top boxes, programmable electronic consumption devices, network PCs, minicomputers, mainframe computers, distributed computing environments including any of the above systems or devices, and the like.

Embodiments of the present invention may be described within the general context of computer-executable instructions executed by a computer, such as a program module. Generally, the program module may include a routine, a program, an object, an assembly, a data structure and the like for implementing particular tasks or achieving particular abstract data types. Embodiments of the present invention may also be implemented in distributed computing environments, in which tasks are performed by remote processing devices connected via a communication network. In the distributed computing environments, program modules may be located in local and remote computer storage media that may include a storage device.

The data structures and computer instructions described in this detailed description are typically stored on a computer-readable storage medium, which may be any device or medium that can store code and/or data for use by a computer system. The computer-readable storage medium may include, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The above description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

What is claimed is:

1. A computer-implemented method for statistics-based machine translation, comprising:
obtaining at least one text to be translated and localized information;
decoding the text to be translated;
generating a plurality of candidate translations for the text to be translated;
for each candidate translation of the plurality of candidate translations, obtaining linguistic translation features according to the text to be translated and the candidate translation;
extracting localized translation features according to the localized information;
applying a translation quality prediction model to calculate translation quality scores for the plurality of candidate translations according to the linguistic translation features and the localized translation features; and
selecting a predetermined number of candidate translations with highest translation quality scores as translations of the text to be translated.

2. The method of claim 1, wherein the localized information includes at least one of application scenario information, user static attributes information, and user historical behavior information; and
wherein the localized translation features include at least one of application scenario features, user static attributes features, and user historical behavior features.

3. The method of claim 2, wherein the statistics-based machine translation method is applied in a search scenario;
wherein the translation quality scores indicate click-through rates for the plurality of candidate translations as search results;
wherein the application scenario information includes one or more query words expressed in a target language;
wherein the application scenario features include at least one of whether a candidate translation includes the query words, a position of the query words in the candidate translation, whether the candidate translation includes any untranslated terms, and a number of terms included in the candidate translation; and
wherein the target language is a language of the candidate translation.

4. The method of claim 1, wherein obtaining the text to be translated further comprises:
obtaining a query expressed in a target language as input by a user;
translating the query expressed in the target language to a query expressed in a source language; and
retrieving the text to be translated according to the query expressed in the source language.

5. The method of claim 1, further comprising:
generating the translation quality prediction model through machine learning by training with a set of historical translation records labeled with localized processing results, wherein each historical translation record in the set includes an original text, a translation text, and one or more localized information.

6. The method of claim 5, wherein the localized information includes at least one of application scenario information, user static attributes information, and user historical behavior information.

7. The method of claim 6, wherein the set of historical translation records is derived from a search scenario;
wherein one or more localized processing results indicate whether the translation text is clicked on when the translation text is used as a search result, or whether merchandise mentioned in the translation text is purchased when the merchandise mentioned in the translation text is included in the search result;
wherein the application scenario information includes a query expressed in a target language; and
the target language is a language of the translation text.

8. The method of claim 5, wherein different target languages correspond to different translation quality prediction models, and the method further comprises:
generating the translation quality prediction model of a target language based on the set of historical translation records of the target language, wherein the target language is a language in which the translation text is expressed.

9. The method of claim 5, further comprising:
applying a preset noisy data filtering technique to eliminate one or more noisy historical translation records from the set of historical translation records before generating the translation quality prediction model.

10. The method of claim 5, wherein generating the translation quality prediction model through machine learning by training with the set of historical translation records labeled with localized processing results further comprises:
obtaining the set of historical translation records;
for each historical translation record of the set of historical translation records, obtaining linguistic translation features of the historical translation record according to the original text and the translation text in the historical translation record, and extracting localized translation features of the historical translation record according to the localized information in the historical translation record; and
using a machine learning technique to generate the translation quality prediction model according to the linguistic translation features, the localized translation features, and localized processing results acquired from each historical translation record.

11. A computing system comprising:
one or more processors; and
a non-transitory computer-readable medium coupled to the one or more processors storing instructions stored that, when executed by the one or more processors, cause the computing system to perform a method for statistics-based machine translation, the method comprising:
obtaining at least one text to be translated and localized information;
decoding the text to be translated;
generating a plurality of candidate translations for the text to be translated;
for each candidate translation of the plurality of candidate translations, obtaining linguistic translation features according to the text to be translated and the candidate translation;
extracting localized translation features according to the localized information;
applying a translation quality prediction model to calculate translation quality scores for the plurality of candidate translations according to the linguistic translation features and the localized translation features; and
selecting a predetermined number of candidate translations with highest translation quality scores as translations of the text to be translated.

12. The system of claim 11, wherein the localized information includes at least one of application scenario information, user static attributes information, and user historical behavior information; and
wherein the localized translation features include at least one of application scenario features, user static attributes features, and user historical behavior features.

13. The system of claim 12, wherein the statistics-based machine translation method is applied in a search scenario;
wherein the translation quality scores indicate click-through rates for the plurality of candidate translations as search results;
wherein the application scenario information includes one or more query words expressed in a target language;
wherein the application scenario features include at least one of whether a candidate translation includes the query words, a position of the query words in the candidate translation, whether the candidate translation includes any untranslated terms, and a number of terms included in the candidate translation; and
wherein the target language is a language of the candidate translation.

14. The system of claim 11, wherein obtaining the text to be translated further comprises:
obtaining a query expressed in a target language as input by a user;
translating the query expressed in the target language to a query expressed in a source language; and
retrieving the text to be translated according to the query expressed in the source language.

15. The system of claim 11, wherein the method further comprises:
generating the translation quality prediction model through machine learning by training with a set of historical translation records labeled with localized processing results, wherein each historical translation record in the set includes an original text, a translation text, and one or more localized information.

16. The system of claim 15, wherein the localized information includes at least one of application scenario information, user static attributes information, and user historical behavior information.

17. The system of claim 16, wherein the set of historical translation records is derived from a search scenario;
wherein one or more localized processing results indicate whether the translation text is clicked on when the translation text is used as a search result, or whether merchandise mentioned in the translation text is purchased when the merchandise mentioned in the translation text is included in the search result;
wherein the application scenario information includes a query expressed in a target language; and
the target language is a language of the translation text.

18. The system of claim 15, wherein different target languages correspond to different translation quality prediction models, and the method further comprises:
generating the translation quality prediction model of a target language based on the set of historical translation records of the target language, wherein the target language is a language in which the translation text is expressed.

19. The system of claim 15, wherein generating the translation quality prediction model through machine learning by training with the set of historical translation records labeled with localized processing results further comprises:
obtaining the set of historical translation records;
for each historical translation record of the set of historical translation records, obtaining linguistic translation features of the historical translation record according to the original text and the translation text in the historical translation record, and extracting localized translation features of the historical translation record according to the localized information in the historical translation record; and
using a machine learning technique to generate the translation quality prediction model according to the linguistic translation features, the localized translation features, and localized processing results acquired from each historical translation record.

20. A non-transitory computer-readable storage medium storing instructions that when executed by a computer cause the computer to perform a method for statistics-based machine translation, the method comprising:
obtaining at least one text to be translated and localized information;
decoding the text to be translated;
generating a plurality of candidate translations for the text to be translated;
for each candidate translation of the plurality of candidate translations, obtaining linguistic translation features according to the text to be translated and the candidate translation;
extracting localized translation features according to the localized information;
applying a translation quality prediction model to calculate translation quality scores for the plurality of candidate translations according to the linguistic translation features and the localized translation features; and
selecting a predetermined number of candidate translations with highest translation quality scores as translations of the text to be translated.
